(19) United States
(12) Patent Application Publication
(10) Pub. No.: US 2012/0083950 A1
(43) Pub. Date: Apr. 5, 2012

(54) ENHANCED STABILITY CONTROL FOR AN ELECTRIC POWERTRAIN

(75) Inventors: Hong Yang, Rochester Hills, MI (US); Anthony L. Smith, Troy, MI (US); Shawn H. Swales, Canton, MI (US)

(73) Assignee: GM GLOBAL TECHNOLOGY OPERATIONS LLC, Detroit, MI (US)

(21) Appl. No.: 12/974,034

(22) Filed: Dec. 21, 2010

Related U.S. Application Data
(60) Provisional application No. 61/388,119, filed on Sep. 30, 2010.

(51) Int. Cl. B60L 15/20; B60K 6/365

(52) U.S. Cl. 701/22; 180/65.285; 903/903

(57) ABSTRACT

A vehicle having an electric powertrain includes a control system for executing a driveline stability control method. A host machine determines vehicle speed prior to an electric-only (EV) mode or EV mode shift/transition, filters an initial motor torque command to the traction motor via a notch filter as a function of vehicle speed to generate a filtered motor torque command, and controls the motor during the EV mode or transition using the filtered motor torque command. The notch filter may have a center frequency and/or a damping coefficient tunable to changing vehicle speed. A control system for the vehicle includes the host machine, a notch filter, and optionally a vehicle speed-based active damping module. The host machine controls the motor during the EV mode or transition using the filtered motor torque command from the filter, and may provide the damping control during the EV mode or transition.

### CROSS REFERENCE TO RELATED APPLICATIONS

This application claims the benefit of U.S. Provisional Patent Application No. 61/388,119, filed on Sep. 30, 2010, which is hereby incorporated by reference in its entirety.

### TECHNICAL FIELD

The present invention relates to a method and a control system for providing enhancing stability control in vehicle having an electric powertrain.

### BACKGROUND

Certain vehicles can be driven using motor torque from one or more electrical traction motors. For example, hybrid electric vehicles can selectively disconnect an internal combustion engine from a transmission input member in an electric-only (EV) operating mode in order to conserve fuel, as well as to deliver immediate motor torque to the transmission input member. The engine can be cranked and fueled automatically above a threshold speed, with engine torque used either alone or in conjunction with motor torque from the traction motor(s) to propel the vehicle. Battery electric vehicles dispense of the engine altogether, and thus operate solely in an EV mode. Extended-range electric vehicles provide a unique combination of technologies, wherein a smaller engine is used solely to power an electric generator beyond a threshold EV range, thereby extending the effective EV range of the vehicle by recharging a battery or directly powering the traction motor(s).

### SUMMARY

A method and a control system are provided herein for use in a vehicle having an electric drivetrain, e.g., a hybrid, a battery electric, or an extended-range electric vehicle. The present method is automatically executed via the control system to maintain driveline stability when the vehicle is operating in a sustained electric-only (EV) mode, or when the vehicle is executing a predetermined EV mode shift or transition. For example, EV launch is a possible EV mode within the scope of the present invention, and a mode shift to or from an EV mode is a possible EV mode transition, both of which could benefit from the stability enhancement of the present method.

When a vehicle operates in an EV mode, the various engine-associated energy absorbing elements, such as drive shaft compliance or compliance provided by optional engine damping assemblies, are disconnected or otherwise isolated from the electric drivetrain. A battery electric vehicle typically lacks such elements. Driveline instability may be created by the combination of high driveline efficiencies in an electric powertrain, which has little inherent damping, and more than one source of torque to be applied to the drive wheels of the vehicle. The present control system and accompanying method can be used to enhance driveline stability control in such vehicles.

In particular, the present control system uses a stability control module in a powertrain torque control loop of the vehicle to improve overall driveline stability control. The stability control module in one embodiment automatically applies a notch filter that varies its filtering capabilities in conjunction with changing vehicle speed, i.e., the stability control module acts in a manner that is fully adaptive to changing vehicle speed. In one embodiment, a lookup table of two or more different notch filters is indexed by vehicle speed and stored in memory, with the method including accessing the table using associated hardware components of the control system.

The center frequency of the notch filter(s) may be optimized for any mechanical resonance present along the driveline at various vehicle speeds, and stored as calibration values for the different vehicle speeds, or alternatively stored as calibrated bands or speed ranges. The control system can adaptively tune the center frequency of the notch filter(s) and damping coefficients of a filtering transfer function, e.g., a Laplace transform, to the present vehicle speed. The stability control module may optionally work in conjunction with any existing active driveline damping control methodologies, i.e., a methodology wherein a damping motor torque command acts directly on an output speed feedback value.

A method for controlling driveline stability in a vehicle having a traction motor and a transmission includes determining a speed of the vehicle prior to entering an EV mode or prior to an EV mode transition, and then filtering, via a control system, an initial motor torque command to the traction motor using a notch filter. The notch filter applies different filtering characteristics with changing vehicle speed to generate a filtered motor torque command. The method further includes controlling the traction motor via the control system using the filtered motor torque command to thereby enhance driveline stability.

The notch filter may have a center frequency and damping coefficient, each being tunable as a function of the changing vehicle speed. For example, the present method may include automatically selecting a center frequency and damping coefficient from a lookup table indexed by vehicle speed.

A vehicle includes an electric fraction motor, a transmission, and a control system. The control system is configured to control driveline stability in the vehicle during an EV operating mode and during a predetermined transition from the EV operating mode. The control system is configured for determining a speed of the vehicle prior to entering the EV operating mode or prior to executing the predetermined transition, and using a notch filter to filter an initial motor torque command. The initial motor torque command is transmitted from a propulsion torque control module of the control system as a function of vehicle speed. The control system thereafter controls the electric traction motor during the EV mode or the predetermined transition using the filtered motor torque command.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having a control system that provides enhanced driveline stability control during a sustained electric-only (EV) operation and during an EV mode shift or transition;

FIG. 2 is a schematic flow diagram describing elements of the control system for the vehicle shown in FIG. 1;

FIG. 3 is a Bode plot describing various properties of a notch filter for the present control system;

FIG. 4 is another Bode plot describing various properties of a notch filter for the present control system; and

FIG. 5 is a flow chart describing a method for controlling driveline stability aboard the vehicle of FIG. 1 during an EV mode and/or EV mode transition.

### DETAILED DESCRIPTION

A vehicle 10 is shown in FIG. 1. The vehicle 10 is shown as a strong hybrid, i.e., a vehicle having an engine 12 that can be used to selectively power the vehicle, and that can be selectively shut off as needed to allow the vehicle to be propelled in an electric-only (EV) mode. Alternatively, the vehicle 10 can be configured as a plug-in hybrid electric vehicle, an extended-range electric vehicle, or a battery electric vehicle without departing from the intended inventive scope.

The vehicle 10 includes a control system 40 that is configured to selectively execute a method 100 by generating and transmitting a set of control signals (arrow 42). The control signals (arrow 42) are used to control driveline stability when operating in an EV operating mode or when executing an EV mode shift or transition, as set forth in detail below. The vehicle 10 includes a transmission 14, shown here in lever diagram form for illustrative clarity. One possible embodiment of the transmission 14 includes a respective first and a second planetary gear set 20 and 30. The first planetary gear set 20 has three nodes 22, 24, and 26. Likewise, the second planetary gear set 30 has three nodes 32, 34, and 36. Depending on the embodiment, the nodes 22, 24, and 26 and the nodes 32, 34, and 36 of the respective first and second gear sets 20 and 30 can be a sun gear, a ring gear, and a carrier member.

The transmission 14 of FIG. 1 has three braking clutches, including an input brake 11, a first brake 13, and a second brake 21. All of the braking clutches selectively connect and disconnect a designated member of the transmission 14 to a stationary member 25 of the transmission. The transmission 14 also has three rotating clutches, i.e., first, second, and third clutches 15, 17, and 19, respectively, which are used to establish the various forward and reverse operating modes.

A first and second electric fraction motor 16 and 18 selectively drive the planetary gear sets 20 and 30, respectively, during different EV operating modes. As shown, the first traction motor 16 may be connected to node 26, e.g., a sun gear, and the traction motor 18 may be connected to node 32, which may also be a sun gear in the same embodiment. A transmission output member 38 is connected to node 34 of the second planetary gear set 30, e.g., a carrier member, with output torque transmitted to a set of drive wheels (not shown) via the transmission output member.

In the embodiment shown in FIG. 1, the vehicle 10 is configured as a two-mode hybrid electric vehicle having a first and a second EV operating mode, which are referred to hereinafter for simplicity as EV1 and EV2, respectively. EV1 is entered with the engine 12 turned off, i.e., not fueled, and with the input brake 11 fully engaged. The transmission 14 is in the first electric-only mode (EV1) when the input brake 11 and the second brake 21 are both engaged. The clutch 15 is engaged in either EV mode. With the input brake 11 engaged and providing a sufficient reaction torque at the first planetary gear set 20, both traction motors 16 and 18 can provide positive propulsion or negative regenerative braking torque as needed.

In the second electric-only mode (EV2), the engine 12 remains off and the input brake 11 remains engaged. The clutch 19 is applied this mode. As with EV1, both traction motors 16 and 18 can provide positive propulsion or negative regenerative braking torque. However, as noted above the lack of engine damping in the EV operating mode(s), e.g., from a separate damper assembly 23 represented schematically in FIG. 1 and/or from any inherent compliance in the engine shafts, can cause a reduction in stability, particularly during abrupt torque changes during an EV operating modes such as EV launch or EV mode transition such as during an EV-to-EV mode shift.

The control system 40 shown in FIG. 1 can include one or more digital computers acting as host machines or servers, each having a microprocessor or central processing unit, sufficient read only memory (ROM), random access memory (RAM), electrically-programmable read only memory (EPROM), a high-speed clock, analog-to-digital (A/D) and digital-to-analog (D/A) circuitry, and input/output circuitry and devices (I/O), as well as appropriate signal conditioning and buffer circuitry. Each set of algorithms or code resident in the control system 40 or readily accessible thereby, including any algorithms or computer code needed for executing the present method 100 as explained below with reference to FIG. 5, can be stored in tangible/non-transient memory and executed as needed by the host machine or other suitable hardware components of the control system to provide the respective functionality of each resident control module.

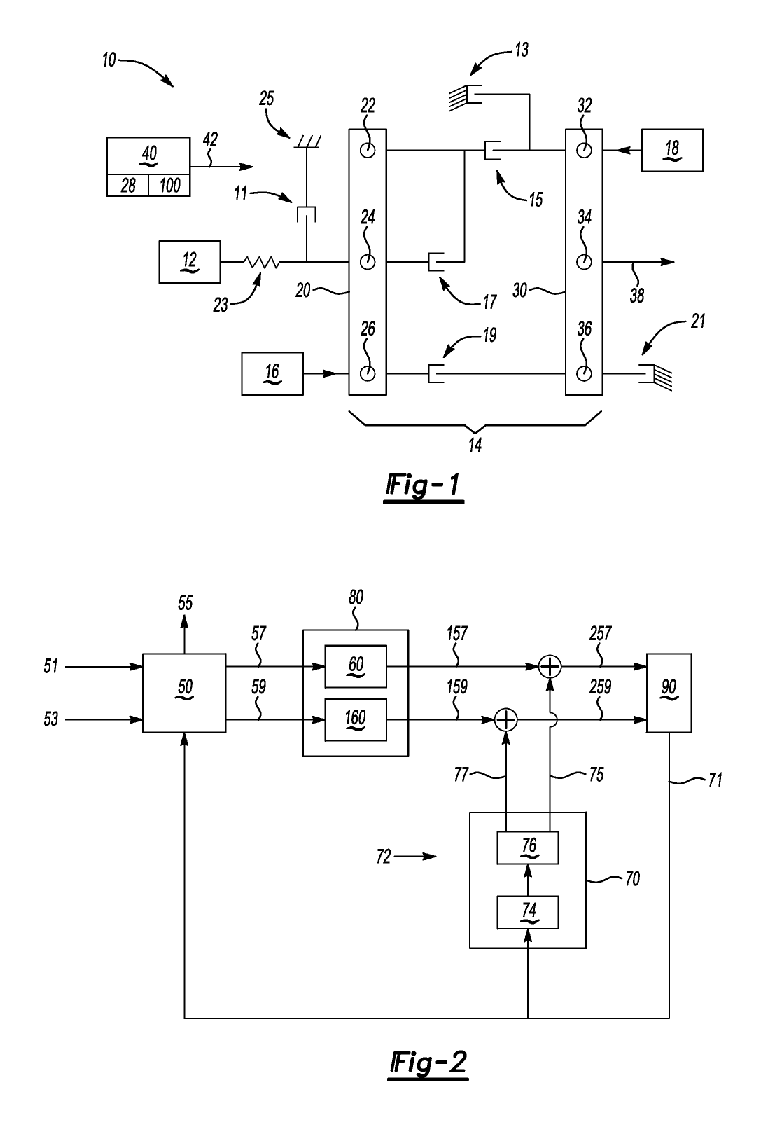

Referring to FIG. 2, the control system 40 of FIG. 1 is shown in schematic form as having a propulsion torque control module 50, a stability control module 80, and an optional active damping control module 70. The propulsion torque control module 50 receives a set of inputs, including an output torque request (arrow 51), a driveline inertia emulation (arrow 53), and a transmission output speed (arrow 71). The output torque request (arrow 51) may be a driver-commanded torque request that is determined via an accelerator or throttle position, braking pressure/travel, etc. The inertia emulation (arrow 53) may be provided from a calibrated model to represent the driveline inertia given a set of known vehicle operating conditions such as speed, acceleration, mass, etc. The transmission output speed (arrow 71) may be a measured or a calculated rotational speed of an output member of the transmission 14 shown in FIG. 1.

Outputs from the propulsion torque control module 50 may include an engine torque command (arrow 55), which is zero in any EV mode, and initial motor torque commands (arrows 57 and 59). In a vehicle having just one fraction motor, only one motor torque command will be output from the torque control module 50, although two motors are described in FIG. 2 for consistency with the vehicle embodiment shown in FIG. 1. The initial motor torque commands (arrows 57 and 59) are fed forward into the stability control module 80 for filtering of the initial motor torque commands.

The stability control module 80 can include at least as many different signal filters as there are traction motors. Therefore, in keeping with the two-mode embodiment shown in FIG. 1 with its use of two traction motors 16 and 18, a first filter 60 may be used for the traction motor 16 and a second filter 160 may be used for the traction motor 18. In order to improve stability at low frequencies while avoiding any negative effects on system responsiveness, the filters 60, 160 may be configured in one possible embodiment as one or more notch filters, each being designed with a middle or center frequency located at or near the calibrated or predetermined lower resonance frequency of the driveline of the vehicle 10.

A notch filter can be represented mathematically by the following transfer function:

$$G ( s ) = \frac{{s}^{2} + 2 {ξ}_{p} \cdot {ω}_{p} \cdot s + {ω}_{p}^{2}}{{s}^{2} + 2 {ξ}_{m} \cdot {ω}_{m} \cdot s + {ω}_{m}^{2}}$$

where ωₘ, and ωₚ are the center frequencies (typically chosen as the same values) and ξₘ, and ξₚ are the damping coefficients for the numerator and denominator, respectively. The center frequencies and the damping coefficients may be stored beforehand as calibration values, e.g., in a lookup table 28 indexed by vehicle speed.

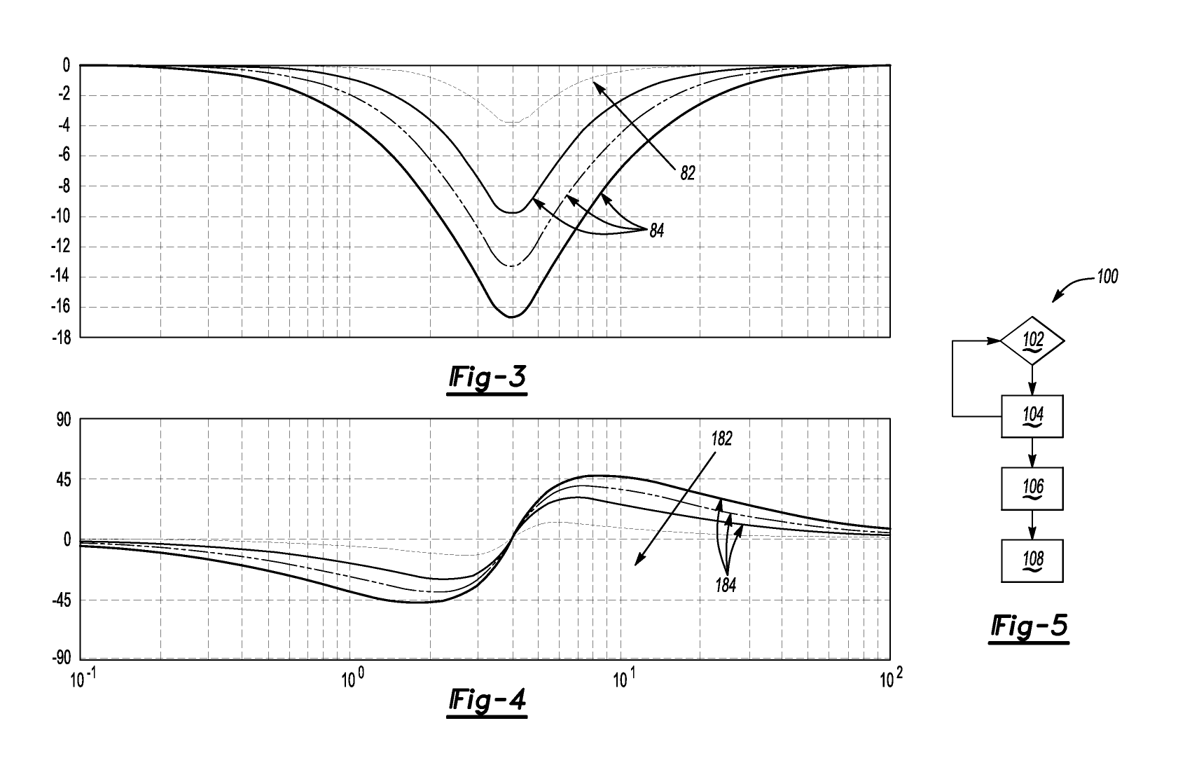

Referring briefly to FIGS. 3 and 4, a notch filter Bode plot is shown with the magnitude (FIG. 3) and the phase (FIG. 4) plotted against frequency. As shown in FIGS. 3 and 4, respectively, arrows 82 and 182 indicate the direction of increasing vehicle speed. Note that the magnitude of damping changes in FIG. 3 in conjunction with an increase in vehicle speed. The deeper the notch, as represented by the various traces 84, the better the resultant stability and damping.

Also note the change in phase in conjunction with vehicle speed in FIG. 4. More phase lead, as represented by the various traces 184, likewise corresponds to improved driveline stability. Larger stability margin and higher damping are thus provided precisely where they are most needed: at lower vehicles speeds. At higher speeds, driver inputs are smoother and require good torque responsiveness, and thus the damping qualities are reduced accordingly. Therefore, smaller stability margin is needed and less damping is used.

Referring once again to FIG. 2, the outputs from the stability control module 80 can include filtered motor torque commands (arrows 157 and 159). In a vehicle having an optional active damping control module 70 as shown, output speed-based driveline damping enhancement provides a corrective damping torque 75 and 77 for each traction motor, e.g., traction motors 16 and 18 of FIG. 1, which are combined with the filtered motor torque commands (arrows 157 and 159) to produce adjusted motor torque commands (arrows 257 and 259).

As understood by those of ordinary skill in the art, active damping control uses feedback from measured engine speed, motor speed(s), wheel speeds, and other values to track and compensate for higher frequency driveline disturbances. The damping control module 70 may include a high-pass filter 74 that filters out any high-frequency disturbances presented in the output speed signal, i.e., above a calibrated frequency threshold, and an active damping gain module 76 that applies calibrated proportional and integral gains as needed to generate the required corrective damping torque commands (arrows 75 and 77) to enhance the active damping control. The torque commands (arrows 75 and 77) are eventually fed into the electrical propulsion system 90 of the vehicle 10 shown FIG. 1, such as the traction motors 16 and 18, and subsequently used to control the traction motors during the EV mode transition. The damping control module 70 may be selectively enabled via a switching signal (arrow 72) such that enhanced active damping is enabled only during the EV transition.

Referring to FIG. 5, the present method 100 is used alone or in conjunction with active driveline damping control, e.g., via the damping control module 70, to thereby enhance driveline stability when operating in an EV mode, e.g., EV launch or in an EV drive mode such as EV1 or EV2 as noted above, and/or during an EV mode transition. The term “EV mode transition” as used herein means a mode shift or transition from or to an EV mode, e.g., from EV1 to EV2 or from EV2 to EV 1, from EV1 or EV2 to an electrically-variable transmission (EVT) mode, or any other transition in which an EV mode is the starting or ending mode.

During such transitions, significant torque perturbations can be caused by torque interruption, torque reversal, and inaccurate clutch torque estimations. The torque perturbations in turn can potentially cause large driveline excitations, which are largely caused by complicated mode transitions including multiple torque and speed control phases. The method 100 is therefore automatically executed by the control system 40 of FIG. 1 to provide improved EV mode transition or shift quality.

Beginning with step 102, the control system 40 of FIG. 1 first determines whether an EV operating mode, i.e., a steady-state EV operation such as EV launch or EV drive, or an EV mode transition as explained above, is active or imminent. This step may include processing information from a hybrid control module or processor portion of or in communication with the control system 40, and/or processing vehicle information such as engine speed, output speed, and/or a driver requested torque. The method 100 proceeds to step 104 if the EV mode transition is active or imminent. Otherwise, step 102 is repeated.

At step 104, vehicle speed is measured or otherwise determined, such as by using speed sensors position with respect to the transmission output member 38 shown in FIG. 1, for example using wheel speed sensors, via calculation, and/or by any other suitable means. Once measured and temporarily recorded in memory, the method 100 proceeds to step 106.

At step 106, the control system 40 of FIG. 1 automatically references a lookup table, e.g., the lookup table 28 shown in FIG. 1, using the speed values measured at step 104, and then selects the center frequencies ωₘ and ωₚ and the damping coefficients ξₘ, and ξₚ of the transfer function G(s) noted above from the lookup table. These values are temporarily recorded in memory within or accessible by the control system 40, and the method 100 thereafter proceeds to step 108.

At step 108, the values from step 106 are applied via a notch filter using the equation set forth above. The electrical propulsion system 90 is thereafter controlled using the outputs from the notch filters 60, 160 of FIG. 2 as explained above.

While the best modes for carrying out the invention have been described in detail, those familiar with the art to which this invention relates will recognize various alternative designs and embodiments for practicing the invention within the scope of the appended claims.

1. A method for controlling driveline stability in a vehicle having a control system, an electric traction motor, and a transmission, wherein the transmission includes a transmission output member that is selectively driven via the electric traction motor in an electric-only (EV) operating mode, the method comprising:
determining a speed of the vehicle prior to entering the EV operating mode or prior to executing a transition from the EV operating mode;
using the control system to filter an initial motor torque command to the electric traction motor, via a notch filter, as a function of vehicle speed, and to thereby generate a filtered motor torque command; and
using the control system to control the electric traction motor during the EV operating mode or the transition using the filtered motor torque command, thereby controlling the driveline stability.

2. The method of claim 1, wherein the notch filter has at least one of a center frequency and a damping coefficient that are tunable using the vehicle speed.

3. The method of claim 2, further comprising:
automatically selecting the center frequency and the damping coefficient, via the control system, from a lookup table that is indexed by the vehicle speed.

4. The method of claim 2, wherein the vehicle includes two electric traction motors, and wherein using the control system to filter an initial motor torque command includes passing a separate initial motor torque command for each of the two electric traction motors through a different notch filter;
wherein each notch filter has a corresponding center frequency and damping coefficient that are tunable as the function of vehicle speed.

5. The method of claim 1, further comprising:
providing an output-speed based driveline damping command during the transition via an active damping control module of the control system in conjunction with the filtered motor torque command.

6. A vehicle comprising:
an electric traction motor;
a transmission having a transmission output member that is selectively driven via the electric traction motor in an electric-only (EV) operating mode; and
a control system configured to control driveline stability in the vehicle during the EV operating mode and during a predetermined transition from the EV operating mode;
wherein the control system is configured for:
determining a speed of the vehicle prior to entering the EV operating mode or prior to executing the predetermined transition;
using a notch filter to filter an initial motor torque command transmitted from a propulsion torque control module of the control system as a function of vehicle speed, and to thereby generate a filtered motor torque command; and
controlling the electric traction motor during the EV mode or the predetermined transition using the filtered motor torque command.

7. The vehicle of claim 6, wherein the electric traction motor includes a pair of electric traction motors and the notch filter includes a pair of notch filters, and wherein the control system uses a different one of the pair of notch filters to filter separate initial motor torque commands to each of the electric traction motors.

8. The vehicle of claim 7, further comprising an engine, wherein:
the transmission includes a first and a second planetary gear set each having a first, a second, and a third node, wherein the second node is connected to the transmission output member;
the first node of the first planetary gear set is selectively connectable to the first node of the second planetary gear set;
the second node of the first planetary gear set is connected to the engine, and is selectively connectable to the first node of the second planetary gear set;
the third node of the first planetary gear set is connected to a first motor of the pair of electric traction motors, and is selectively connected to the third node of the second planetary gear set; and
a second motor of the pair of electric traction motors is connected to the first node of the second planetary gear set.

9. The vehicle of claim 6, wherein the notch filter has at least one of a center frequency and a damping coefficient that are tunable using the vehicle speed.

10. The vehicle of claim 9, wherein the control system is configured to automatically select the center frequency and the damping coefficient from a lookup table that is indexed by the vehicle speed.

11. The vehicle of claim 10, wherein the vehicle includes two electric traction motors, and wherein the control system is configured to automatically select the center frequency and the damping coefficient for each of the two electric traction motors from a lookup table that is indexed by the vehicle speed.

12. The vehicle of claim 10, wherein the control system includes an active damping control module configured for providing an output-speed based driveline damping command during the transition.

13. The vehicle of claim 6, wherein the EV operating mode is a steady-state EV operation and the transition is an EV-to-EV mode transition.

14. The vehicle of claim 13, wherein the control system is configured to provide the filtered motor torque command in conjunction with an output-speed based damping torque command during the EV-to-EV mode transition.

15. A control system for a vehicle having an electric traction motor and a transmission, wherein the transmission includes an output member that is selectively driven via the electric traction motor in an electric-only (EV) operating mode, the control system comprising:
a host machine configured for determining a speed of the vehicle prior to entering the EV mode or an EV mode transition; and
a notch filter applied by the host machine that filters an initial motor torque command to the electric traction motor as a function of vehicle speed, and that generates a filtered motor torque command;
wherein the host machine controls the electric traction motor during the EV mode or the EV mode transition using the filtered motor torque command to thereby enhance driveline stability during the EV mode or the EV mode transition.

16. The control system of claim 15, wherein the EV operating mode is a steady-state EV operation and the EV mode transition is an EV-to-EV mode transition.

17. The control system of claim 16, wherein the host machine is configured to provide the filtered motor torque command in conjunction with an output-speed based damping torque command only during the EV-to-EV mode transition.

18. The control system of claim 17, further comprising:
a stability control module for providing the filtered motor torque command;
a propulsion torque control module for generating and transmitting initial motor torque commands to the stability control module; and
an active damping control module for generating and transmitting the output-speed based damping torque command to the stability control module only when enabled by a switching signal.
